(19) United States
(12) Patent Application Publication
(10) Pub. No.: US 2014/0356584 A1
(43) Pub. Date: Dec. 4, 2014

(54) TRANSPARENT CONDUCTIVE FILM

(71) Applicants: NANCHANG O-FILM TECH CO., LTD., Nanchang (CN); SUZHOU O-FILM TECH CO., LTD., Suzhou City (CN); SHENZHEN O-FILM TECH CO., LTD., Shenzhen City (CN)

(72) Inventors: YUNLIANG YANG, Nanchang (CN); Lidong Liu, Nanchang (CN); Chuanxin Cheng, Nanchang (CN); Tao Xu, Nanchang (CN)

(73) Assignees: NANCHANG O-FILM TECH CO., LTD., Nanchang (CN); SUZHOU O-FILM TECH CO., LTD., Suzhou City (CN); SHENZHEN O-FILM TECH CO., LTD., Shenzhen City (CN)

(21) Appl. No.: 14/257,887

(22) Filed: Apr. 21, 2014

(30) Foreign Application Priority Data
May 30, 2013 (CN) 201310210466.X

(51) Int. Cl. H01B 5/14

(52) U.S. Cl. CPC H01B 5/14
USPC 428/173

(57) ABSTRACT

A transparent conductive film includes: a substrate having a first surface and a second surface opposite to the first surface; a first grid groove, defined in the first surface of the substrate, the bottom of the first grid groove being of non-planar structure; and a first conductive layer, including a first conductive grid made of a conductive material filled in the first grid groove. Since the bottom of the first grid groove is not planar, it is beneficial to releasing tension as the liquid conductive material contacts the bottom of the first grid groove, so as to avoid the liquid conductive material shrinking into a plurality of spherical or near-spherical structures due to large tension, thereby reducing probability of the conductive material being formed as a plurality of spaced spherical or near-spherical structures after sintered, improving connectivity inside the conductive material, and guaranteeing conductivity of the transparent conductive film.

### CROSS REFERENCE TO RELATED APPLICATIONS

This application claims priority to Chinese Patent Application No. 201310210466.X, filed on May, 30, 2013, entitled “Transparent Conductive Film”, which is hereby incorporated by reference in its entirety.

### TECHNICAL FIELD

The present invention relates to the field of electronic technologies and, in particular, to a transparent conductive film.

### BACKGROUND

A transparent conductive film, which is a thin film with good conductivity and high transmittance within visible waveband, is widely applied in panel display, photovoltaic device, touch panel and electromagnetic shielding etc., and has extremely broad market potential.

Generally, the existing transparent conductive film at present can be categorized as non-graphical or graphical type. The former, i.e. a non-graphical transparent conductive film, which is applied in applications such as touch panels, etc., needs to be graphicalized through a plurality of processes such as exposure, development, etching and cleaning etc. The latter, i.e. a graphical transparent conductive film, is embossed with grooves, then a liquid conductive material is filled into the grooves, and then the conductive material is sintered into a solid flexible film line structure. Since the complex and environment-polluting graphical process is omitted, the graphical transparent conductive film becomes a main development direction.

However, the liquid conductive material, when filled into the grooves, easily shrinks into a plurality of spherical or near-spherical structures; after being sintered, the conductive material is formed as a plurality of spaced spherical or near-spherical structures, resulting in that the connectivity inside the conductive material is poor, which affects the conductivity of the transparent conductive film.

### SUMMARY

In view of the above, it is necessary to provide a transparent conductive film aiming at the problem of poor connectivity inside the conductive material which affects the conductivity of the transparent conductive film.

A transparent conductive film includes:

a substrate, including a first surface and a second surface opposite to the first surface; and

a first grid groove, defined in the first surface of the substrate, the bottom of the first grid groove is of non-planar structure;

a first conductive layer, including a first conductive grid made of a conductive material filled in the first grid groove.

In one of the embodiments, the shape of the non-planar structure includes at least one of V-shape or arc-shape.

In an embodiment, the substrate includes a base plate and a first gluey layer, the first surface is provided on a surface of the first gluey layer away from the base plate.

In an embodiment, the transparent conductive film further includes a second conductive layer, the second surface of the substrate defines a second grid groove therein, a bottom of the second grid groove is of non-planar structure, the second conductive layer includes a second conductive grid made of a conductive material filled in the second grid groove.

In an embodiment, the transparent conductive film further includes a second conductive layer, the substrate includes a first gluey layer, a base plate and a second gluey layer, the first gluey layer and the second gluey layer are laminatedly provided at a same side of the base plate, the first surface is provided on a surface of the first gluey layer away from the base plate, the second gluey layer is adhered to the first surface, a surface of the second gluey layer away from the first gluey layer defines a second grid groove, the bottom of the second grid groove is of non-planar structure, the second conductive layer includes a second conductive grid made of a conductive material filled in the second grid groove.

In an embodiment, the transparent conductive film further includes a second conductive layer, the substrate includes a first gluey layer, a base plate and a second gluey layer, the base plate is provided between the first gluey layer and the second gluey layer, the first surface is provided on a surface of the first gluey layer away from the base plate, the second gluey layer is adhered to a surface of the base plate away from the first gluey layer, a surface of the second gluey layer away from the base plate defines a second grid groove, the bottom of the second grid groove is of non-planar structure, the second conductive layer includes a second conductive grid made of a conductive material filled in the second grid groove.

In an embodiment, the ratio of a depth to a width of the first grid groove is not smaller than 1, and/or the ratio of a depth to a width of the second grid groove is not smaller than 1.

In an embodiment, the depth of the first grid groove and/or the second grid groove is in a range of 2 μm to 6 μm, the width of the first grid groove and/or the second grid groove is in a range of 0.2 μm to 5 μm.

In an embodiment, the grid shape of the first grid groove and/or the second grid groove is a regular grid or a random grid.

In an embodiment, the conductive material of the first conductive grid and/or the second conductive grid is at least one of metal, carbon nano tube, graphene ink and conductive polymeric material.

In the transparent conductive film above, a first grid groove is defined in a first surface of a substrate, a conductive material is filled into the first grid groove to form a first conductive grid so as to constitute a first conductive layer, and the bottom of the first grid groove is of non-planar structure. In this way, when a liquid conductive material is filled into the first grid groove, since the bottom of the first grid groove is not planar, it is beneficial to releasing the tension generated during the liquid conductive material contacting the bottom of the first grid groove, so as to avoid the liquid conductive material shrinking into a plurality of spherical or near-spherical structures due to large tension, thus, the probability of the conductive material being formed as a plurality of spaced spherical or near-spherical structures after sintered is reduced, the connectivity inside the conductive material after sintered is improved, and the conductivity of the transparent conductive film is guaranteed.

### BRIEF DESCRIPTION OF DRAWINGS

FIG. 1 is a schematic structural diagram of a transparent conductive film according to an implementation manner;

FIG. 2 is a schematic structural diagram of a transparent conductive film according to Embodiment 1;

FIG. 3 is a schematic structural diagram of a transparent conductive film according to Embodiment 2;

FIG. 4 is a schematic structural diagram of a transparent conductive film according to Embodiment 3;

FIG. 5 is a schematic structural diagram of a transparent conductive film according to Embodiment 4;

FIG. 6 is a schematic structural diagram of a transparent conductive film according to Embodiment 5;

FIG. 7 is a schematic structural diagram of a first conductive grid according to an implementation manner;

FIG. 8 is a schematic structural diagram of a first conductive grid according to another implementation manner.

### DESCRIPTION OF EMBODIMENTS

In order to make the above objectives, characteristics and advantages of the transparent conductive film more clear, detailed descriptions of embodiments of the transparent conductive film are given with reference to accompanying drawings. The following descriptions illustrate specific details so as to facilitate a sufficient understanding of the transparent conductive film. However, the transparent conductive film can be implemented by many other manners which are different from those described here, a person skilled in the art can make similar modifications without departing from the principle of the present invention, thus, the transparent conductive film is not limited to the following embodiments.

Unless otherwise defined, the technical and scientific terminologies adopted in the description are of the same meaning as generally understood by those skilled in the field of transparent conductive films. The terminologies used in the specification of the transparent conductive film aims to describe the embodiments, but not to limit the transparent conductive film. The terminology “and/or” includes any and all combinations of one or more relevant listed items.

The transparent conductive film is described below in further detail with reference to the accompanying drawings and embodiments.

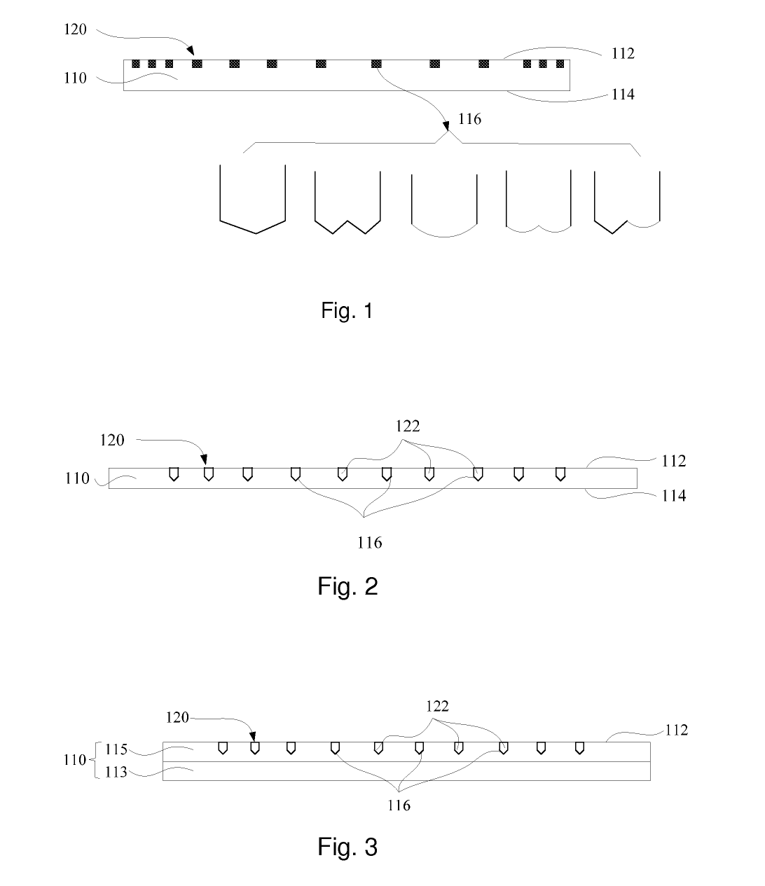

As shown in FIG. 1, a transparent conductive film includes a substrate 110, a first conductive layer 120. The substrate 110 includes a first surface 112 and a second surface 114 opposite to the first surface 112, a first grid groove 116 is defined in the first surface 112 of the substrate 110, the bottom of the first grid groove 116 is of non-planar structure, a first conductive layer 120 includes a first conductive grid 122 made of a conductive material filled in the first grid groove 116. The first grid groove 116 can be formed through embossing by using a graphical embossing template corresponding to the first conductive grid 122.

In the transparent conductive film above, the first grid groove 116 is defined in the first surface 112 of the substrate 110, the conductive material is filled into the first grid groove 116 to form the first conductive grid 122 so as to constitute the first conductive layer 120, the bottom of the first grid groove 116 is of non-planar structure. In this way, when a liquid conductive material is filled into the first grid groove 116, since the bottom of the first grid groove 116 is not planar, it is beneficial to releasing the tension as the liquid conductive material contacts the bottom of the first grid groove 116, so as to avoid the liquid conductive material shrinking into a plurality of spherical or near-spherical structures due to large tension, thus, the probability of the conductive material being formed as a plurality of spaced spherical or near-spherical structures after sintered is reduced, the connectivity inside the conductive material after sintered is improved, and the conductivity of the transparent conductive film is guaranteed.

Please refer to FIG. 1, in an embodiment, the shape of the non-planar structure of the bottom of the first grid groove 116 includes at least one of V-shape or arc-shape. When the liquid conductive material is filled into the first grid groove 116, the conductive material fills the bottom of the first grid groove 116 according to the shape of the non-planar structure when flowing to the bottom. The shape of the non-planar structure designed includes at least one of V-shape or arc-shape, a specific angle is formed by the V-shape or the arc-shape, which results in that a part of tension of the conductive material is counteracted so as to reduce the tension on the surface of the conductive material, and also results in that a downward force of the conductive material is formed, so as to achieve a better contact between the conductive material and the surface of the first grid groove 116, and avoid the liquid conductive material shrinking into a plurality of spherical or near-spherical structures, thus, the probability of the conductive material being formed as a plurality of spaced spherical or near-spherical structures after sintered is reduced, the connectivity inside the conductive material after sintered is improved, and the conductivity of the transparent conductive film is guaranteed.

Specifically, the shape of the non-planar structure can be a single V-shape or a single arc-shape, or can be a regular zigzag shape combined by multiple V-shapes, or a wave shape combined by multiple arc-shapes or a non-planar structure combined by V-shape and arc-shape etc. Obviously, the non-planar structure can also be other shapes, as long as the bottom of the first grid groove 116 is not planar.

The depth and width of the first grid groove 116 are in micron level, in order to guarantee that the non-planar structure of the bottom of the first grid groove 116 improves the connectivity inside the conductive material after sintered, but does not affect the conductivity of the transparent conductive film, the amplitude of fluctuation of the non-planar structure is properly set as 500 nm to 1000 nm. In this way, even if the height of the non-planar structure is of nano scale, the overall numeric of the depth and width of the first grid groove 116 will not be affected, thus the conductivity of the transparent conductive material is further guaranteed.

Please refer to FIG. 3, in Embodiment 2, the substrate 110 includes a base plate 113 and a first gluey layer 115, the first surface 112 is provided on the surface of the first gluey layer 115 away from the base plate 113. The first gluey layer 115 is coated on a surface of the base plate 113, the first grid groove 116 is formed on the surface of the first gluey layer 115 away from the base plate 113 through embossing by using a graphical embossing template corresponding to the first conductive grid 122, a conductive material is filled into the first grid groove 116 to form the first conductive grid 122, so as to constitute the first conductive layer 120. The first gluey layer 115 can be used for insulation and molding. It should be noted that, in other embodiments, such as Embodiment 1 as shown in FIG. 2, the transparent substrate 110 may only include the base plate 113, the first grid groove 116 is directly defined in a surface of the base plate 113, thus, the first gluey layer 115 is not necessary.

The material of the first gluey layer 115 can be curable adhesive, embossing adhesive or polycarbonate, the material of the base plate 113 can be polyethylene terephthalate (Polyethylene Terephthalate, PET) plastic, polycarbonate (Polycarbonate, PC), polymethylmethacrylate (Polymethylmethacrylate, PMMA) or glass. In this embodiment, the material of the base plate 113 is ethylene terephthalate, and a transparent insulation material is the preferred.

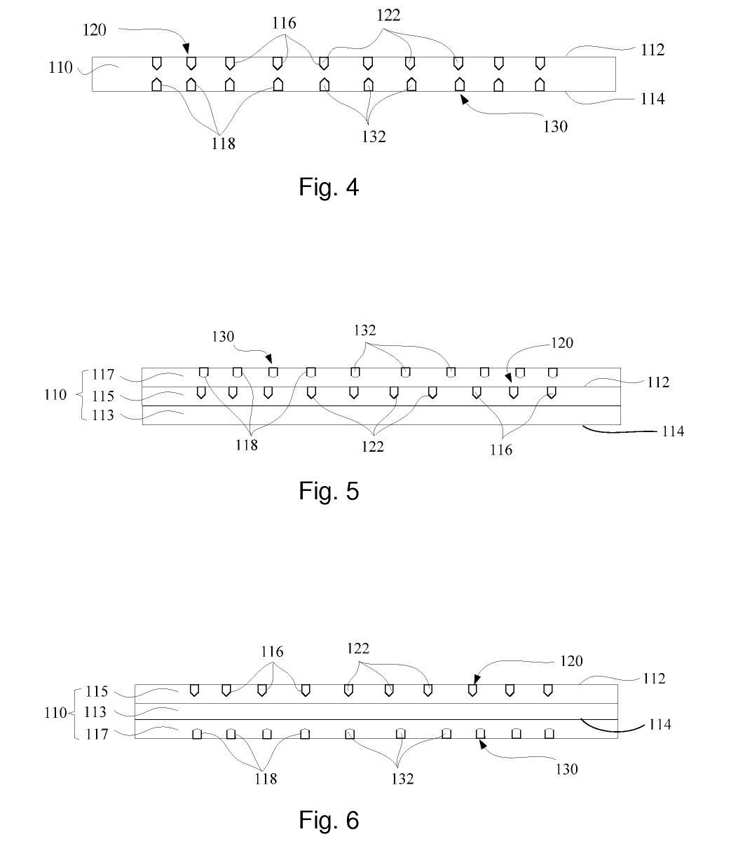

Please refer to FIG. 4, in Embodiment 3, the transparent conductive film is of double-layer structure, which includes a first conductive layer 120 and a second conductive layer 130, a second grid groove 118 is defined in a second surface 114 of the substrate 110, the bottom of the second grid groove 118 is of non-planar structure, the second conductive layer 130 includes a second conductive grid 132 made of a conductive material filled in the second grid groove 118. By providing two conductive layers on the same substrate 110, the thickness of the transparent conductive film can be decreased, the cost is reduced and the light transmittance of the transparent conductive film is improved. The non-planar structure of the bottom of the second grid groove 118 is of the same structure and function with the non-planar structure of the bottom of the first grid groove 116 as illustrated above, which will not be repeated here. The second grid groove 118 can be formed through embossing by using a graphical embossing template corresponding to the second conductive grid 132.

Please refer to FIG. 5, in Embodiment 4, the transparent conductive film is of double-layer structure, which includes a first conductive layer 120 and a second conductive layer 130, the substrate 110 includes a first gluey layer 115, a base plate 113 and a second gluey layer 117, the first gluey layer 115 and the second gluey layer 117 are laminatedly provided at the same side of the base plate 113; the first surface 112 is provided on the surface of the first gluey layer 115 away from the base plate 113, the second gluey layer 117 is adhered to the first surface 112, the surface of the second gluey layer 117 away from the first gluey layer 115 is provided with a second grid groove 118, the bottom of the second grid groove 118 is of non-planar structure, and the second conductive layer 130 includes a second conductive grid 132 made of a conductive material filled in the second grid groove 118. The first gluey layer 115 and the second gluey layer 117 can both be used for insulation and molding. By providing two conductive layers on the same substrate 110, the thickness of the transparent conductive film can be decreased, the cost is reduced and the light transmittance of the transparent conductive film is improved. The non-planar structure of the bottom of the second grid groove 118 is of the same structure and function with the non-planar structure of the bottom of the first grid groove 116 as illustrated above, which will not be repeated here. The first grid groove 116 is formed through embossing the first surface 112 by using a graphical embossing template corresponding to the first conductive grid 122, and the second grid groove 118 is formed through embossing the surface of the second gluey layer 117 away from the first gluey layer 115 by using a graphical embossing template corresponding to the second conductive grid 132. It should be noted that, in other embodiments, the transparent substrate 110 can only include the base plate 113, the second grid groove 118 is directly defined in the surface of the base plate 113 away from the first conductive layer 120, thus, the second gluey layer 117 is not necessary. Where, the materials of the first gluey layer 115 and the second gluey layer 117 can both be curable adhesive, embossing adhesive or polycarbonate.

Please refer to FIG. 6, in Embodiment 5, the transparent conductive film is of double-layer structure, which includes a first conductive layer 120 and a second conductive layer 130, the substrate 110 includes a first gluey layer 115, a base plate 113 and a second gluey layer 117; the base plate 113 is provided between the first gluey layer 115 and the second gluey layer 117, the first surface 112 is provided on the surface of the first gluey layer 115 away from the base plate 113, the second gluey layer 117 is adhered to the surface of the base plate 113 away from the first gluey layer 115; the surface of the second gluey layer 117 away from the base plate 113 is provided with a second grid groove 118, the bottom of the second grid groove 118 is of non-planar structure, and the second conductive layer 130 includes a second conductive grid 132 made of a conductive material filled in the second grid groove 118. The first gluey layer 115 and the second gluey layer 117 can both be used for insulation and molding. By providing two conductive layers on the same substrate 110, the thickness of the transparent conductive film can be decreased, the cost is reduced and the light transmittance of the transparent conductive film is improved. The non-planar structure of the bottom of the second grid groove 118 is of the same structure and function with the non-planar structure of the bottom of the first grid groove 116 as illustrated above, which will not be repeated here. The first grid groove 116 is formed through embossing the first surface 112 by using a graphical embossing template corresponding to the first conductive grid 122, and the second grid groove 118 is formed through embossing the surface of the second gluey layer 117 away from the base plate 113 by using a graphical embossing template corresponding to the second conductive grid 132. It should be noted that, in other embodiments, the transparent substrate 110 may only include the base plate 113, the second grid groove 118 is directly defined in the surface of the base plate 113 away from the first conductive layer 120, thus, the second gluey layer 117 is not necessary. Where, the materials of the first gluey layer 115 and the second gluey layer 117 can both be curable adhesive, embossing adhesive or polycarbonate.

In an embodiment, the conductive material is a three-dimensional substance with anisotropy, of which the thermal expansion coefficient in the direction parallel to the layer is much less than that in the direction perpendicular to the layer. Therefore, when sintering the conductive material filled into the grid groove, if the depth of the grid groove is less than the width thereof, the conductive material will break due to an unbearable perpendicular tensile stress, thus, the ratio of the depth to the width of the first grid groove 116 can be properly set as not smaller than 1, the ratio of the depth to the width of the second grid groove 118 can be properly set as not smaller than 1, so as to guarantee that the conductive material filled into the groove will not break during the process of sintering molding, and guarantee the conductivity of the transparent conductive film. For the convenience of description, the term grid groove generally represents the first grid groove 116 and the second grid groove 118.

In an embodiment, the depth of the first grid groove 116 and/or the second grid groove 118 is properly set as 2 μm to 6 μm, the width of the first grid groove 116 and/or the second grid groove 118 is properly set as 0.2 μm to 5 μm. In this embodiment, the maximum depth of the groove is 3 μm, the maximum width is 2.2 μm.

As shown in FIG. 8, the grid shape of the first conductive grid 122 and/or the second conductive grid 132 is regular grid. The first conductive grid 122 includes multiple first grid units, the second conductive grid 132 includes multiple second grid units, the grid shapes of the first conductive grid 122 and/or the second conductive grid 132 are both regular grid, that is, the grid cycles of all first grid units and/or second grid units are the same; the grid cycle refers to the size of each grid unit, that is, the grid shape of the first conductive grid 122 and/or the second conductive grid 132 is regular grid. In this way, when fitting the transparent conductive film with other display devices, in particular for those with smaller screens, the phenomenon of displaying disorder of the pictures can be avoided.

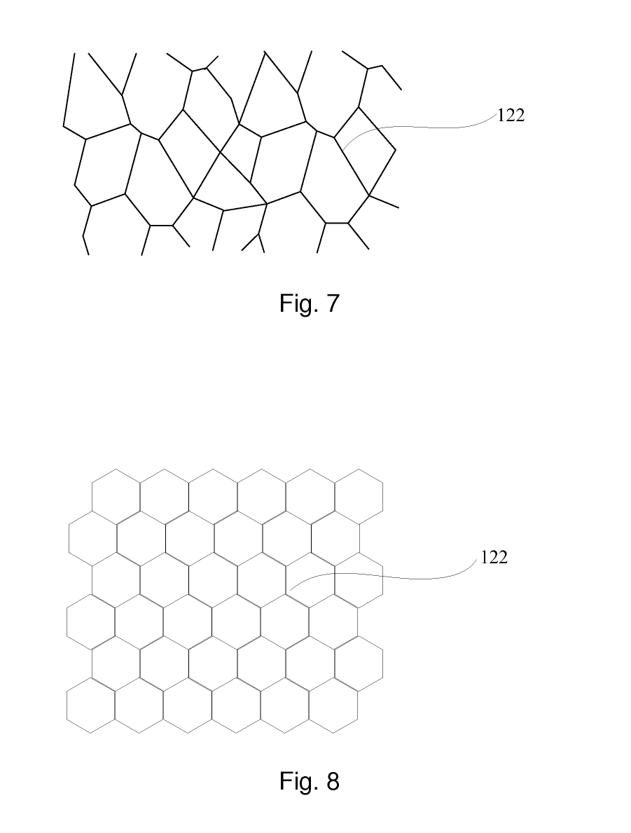

As shown in FIG. 7, the grid shape of the first conductive grid 122 and/or the second conductive grid 132 is random grid. In this way, when fitting the transparent conductive film with other display devices, in order to avoid Moire fringe, the grid shape of the first conductive grid 122 and/or the second conductive grid 132 is random grid, that is, the grid cycles of at least two first grid units and/or at least two second grid units are different, the first grid units and the second grid units are distributed in each angle of the transparent conductive film. Where, the grid cycle is the size of each gird unit. The Moire fringe is an optical phenomenon, which is a visual effect caused by interference of two lines or two objects at constant angle and frequency, when human eyes cannot distinguish these two lines or two objects, only the interference pattern can be seen, such optical phenomenon is called Moire fringe. Where, the shapes of the first gird unit and the second grid unit can be rhombus, rectangular, parallelogram, curved quadrilateral or polygon, the curved quadrilateral has four curved edges, the opposite two curved edges have the same shape and curve trend.

In an embodiment, the conductive material of the first conductive grid 122 and/or the second conductive grid 132 is at least one of metal, carbon nano tube, graphene ink and conductive polymeric material. The metal can include one of gold, silver, copper, aluminum, nickel, zinc or metal alloy of at least two kinds thereof. In this embodiment, the conductive material is nano silver ink, the solid content of the silver ink is 35%, after filled into the first grid groove 116 and sintered, the material represents as a solid flexible silver wire, and the sintering temperature can be 150 degrees centigrade. It should be understood that, the corresponding function can be achieved as long as the material used to prepare the first conductive layer 120 and the second conductive layer 130 is an electrical conductor.

The embodiments above only describe several implementation manners of the present invention, the descriptions are in detail, but this should not be understood as a limit of the scope of the present invention. It should be noted that, those skilled in the art can make multiple alternations and improvements without departing from the conception of the present invention, which all fall within the protection scope of the present invention. Therefore, the protection scope of the present invention is subject to the appended claims.

What is claimed is:

1. A transparent conductive film, characterized by comprising:
a substrate, comprising a first surface and a second surface opposite to the first surface; and
a first grid groove, defined in the first surface of the substrate, a bottom of the first grid groove is of non-planar structure;
a first conductive layer, comprising a first conductive grid made of a conductive material filled in the first grid groove.

2. The transparent conductive film according to claim 1, wherein a shape of the non-planar structure comprises at least one of V-shape or arc-shape.

3. The transparent conductive film according to claim 1, wherein the substrate comprises a base plate and a first gluey layer, the first surface is provided on a surface of the first gluey layer away from the base plate.

4. The transparent conductive film according to claim 1, comprising a second conductive layer, wherein the second surface of the substrate is provided with a second grid groove, a bottom of the second grid groove is of non-planar structure, the second conductive layer comprises a second conductive grid made of a conductive material filled in the second grid groove.

5. The transparent conductive film according to claim 1, comprising a second conductive layer, wherein the substrate comprises a first gluey layer, a base plate and a second gluey layer, the first gluey layer and the second gluey layer are laminatedly provided on a same side of the base plate, the first surface is provided on a surface of the first gluey layer away from the base plate, the second gluey layer is adhered to the first surface, a surface of the second gluey layer away from the first gluey layer is provided with a second grid groove, a bottom of the second grid groove is of non-planar structure, and the second conductive layer comprises a second conductive grid made of a conductive material filled in the second grid groove.

6. The transparent conductive film according to claim 1, comprising a second conductive layer, wherein the substrate comprises a first gluey layer, a base plate and a second gluey layer, the base plate is provided between the first gluey layer and the second gluey layer, the first surface is provided on a surface of the first gluey layer away from the base plate, the second gluey layer is adhered to a surface of the base plate away from the first gluey layer, a surface of the second gluey layer away from the base plate is provided with a second grid groove, a bottom of the second grid groove is of non-planar structure, and the second conductive layer comprises a second conductive grid made of a conductive material filled in the second grid groove.

7. The transparent conductive film according to claim 4, wherein a ratio of a depth to a width of the first grid groove is not smaller than 1, and/or a ratio of a depth to a width of the second grid groove is not smaller than 1.

8. The transparent conductive film according to claim 7, wherein the depth of the first grid groove and/or the second grid groove is in a range of 2 μm to 6 μm, the width of the first grid groove and/or the second grid groove is in a range of 0.2 μm to 5 μm.

9. The transparent conductive film according to claim 5, wherein a ratio of a depth to a width of the first grid groove is not smaller than 1, and/or a ratio of a depth to a width of the second grid groove is not smaller than 1.

10. The transparent conductive film according to claim 9, wherein the depth of the first grid groove and/or the second grid groove is in a range of 2 μm to 6 μm, the width of the first grid groove and/or the second grid groove is in a range of 0.2 μm to 5 μm.

11. The transparent conductive film according to claim 6, wherein a ratio of a depth to a width of the first grid groove is not smaller than 1, and/or a ratio of a depth to a width of the second grid groove is not smaller than 1.

12. The transparent conductive film according to claim 11, wherein the depth of the first grid groove and/or the second grid groove is in a range of 2 μm to 6 μm, the width of the first grid groove and/or the second grid groove is in a range of 0.2 μm to 5 μm.

13. The transparent conductive film according to claim 4, wherein a grid shape of the first grid groove and/or the second grid groove is a regular grid or a random grid.

14. The transparent conductive film according to claim 5, wherein a grid shape of the first grid groove and/or the second grid groove is a regular grid or a random grid.

15. The transparent conductive film according to claim 6, wherein a grid shape of the first grid groove and/or the second grid groove is a regular grid or a random grid.

16. The transparent conductive film according to claim 4, wherein the conductive material of the first conductive grid and/or the second conductive grid is at least one of metal, carbon nano tube, graphene ink and conductive polymeric material.

17. The transparent conductive film according to claim 5, wherein the conductive material of the first conductive grid and/or the second conductive grid is at least one of metal, carbon nano tube, graphene ink and conductive polymeric material.

18. The transparent conductive film according to claim 6, wherein the conductive material of the first conductive grid and/or the second conductive grid is at least one of metal, carbon nano tube, graphene ink and conductive polymeric material.
